(19) United States
(12) Patent Application Publication
(10) Pub. No.: US 2015/0186160 A1
(43) Pub. Date: Jul. 2, 2015

(54) CONFIGURING PROCESSOR POLICIES BASED ON PREDICTED DURATIONS OF ACTIVE PERFORMANCE STATES

(71) Applicant: Advanced Micro Devices, Inc., Sunnyvale, CA (US)

(72) Inventors: Manish Arora, Dublin, CA (US); Indrani Paul, Round Rock, TX (US); Yasuko Eckert, Kirkland, WA (US); Nuwan S. Jayasena, Sunnyvale, CA (US); Srilatha Manne, Portland, OR (US)

(73) Assignee: Advanced Micro Devices, Inc., Sunnyvale, CA (US)

(21) Appl. No.: 14/146,588

(22) Filed: Jan. 2, 2014

(51) Int. Cl. G06F 9/445; G06F 11/34; G06F 12/08

(52) U.S. Cl. CPC G06F 9/44505; G06F 12/0815; G06F 12/0864; G06F 11/3423

(57) ABSTRACT

Durations of active performance states of components of a processing system can be predicted based on one or more previous durations of an active state of the components. One or more entities in the processing system such as processor cores or caches can be configured based on the predicted durations of the active state of the components. Some embodiments configure a first component in a processing system based on a predicted duration of an active state of a second component of the processing system. The predicted duration is predicted based on one or more previous durations of an active state of the second component.

### BACKGROUND

1. Field of the Disclosure

The present disclosure relates generally to processing devices and, more particularly, to the performance states of processing devices.

2. Description of the Related Art

Components in processing devices, such as central processing units (CPUs), graphics processing units (GPUs), and accelerated processing units (APUs), can operate in different performance states. For example, a component of a processing device may perform tasks such as executing instructions in an active state. The component may conserve power by entering an idle state when there are no instructions to be executed or other tasks to be performed by the component. If the component is idle for a relatively long time, power supplied to the component of the processing device may be gated so that no current is supplied to the component, thereby reducing stand-by and leakage power consumption while the component is in the power-gated state. For example, a processor core in a CPU can be power gated if the processor core has been idle for more than a predetermined time interval.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system in accordance with some embodiments.

FIG. 2 is a block diagram of policy management logic for setting one or more policies of the processing system in FIG. 1 according to some embodiments.

FIG. 3 is a diagram of a two-level adaptive global predictor that may be used by the policy management logic shown in FIG. 2 in accordance with some embodiments.

FIG. 4 is a diagram of a two-level adaptive local predictor that may be used by the policy management logic shown in FIG. 2 in accordance with some embodiments.

FIG. 5 is a block diagram of a tournament predictor that may be implemented in the policy management logic shown in FIG. 2 in accordance with some embodiments.

FIG. 6 is a flow diagram of a method of configuring a processor core of the processing system shown in FIG. 1 according to some embodiments.

FIG. 7 is a flow diagram of a method of configuring a cache of the processing system shown in FIG. 1 according to some embodiments.

FIG. 8 is a flow diagram of a method of configuring a processing device that has multiple cores in the processing system shown in FIG. 1 according to some embodiments.

FIG. 9 is a flow diagram illustrating a method for designing and fabricating an integrated circuit device implementing at least a portion of a component of a processing system in accordance with some embodiments.

### DETAILED DESCRIPTION OF EMBODIMENT(S)

Processing systems can manage the performance states of processing devices such as central processing units (CPUs), graphics processing units (GPUs), or accelerated processing units (APUs) based on performance policies. For example, dynamic voltage and frequency scaling (DVFS) may be used to manage the performance states of the processing devices implemented in a processing system such as a system-on-a-chip (SOC), e.g., by increasing or decreasing the voltage or frequency supplied to active components in the processing device based on measured values of performance counters implemented by the SOC. Cache management policies may be used to configure caches in the processing devices based on measured values of the performance counters. Other policies may also be used to decide whether to allocate or migrate tasks among processor cores or schedule hardware or software overhead tasks based on measured values of the performance counters. However, these performance policies do not account for the durations of the performance states of the components of the processing devices.

The power consumption of a processing system may be reduced, and the overall performance of the system may be improved, by making performance policy decisions based at least in part on predicted durations of the performance states of processing devices in the processing system. Durations of the performance states may be predicted using linear prediction techniques, filtered linear prediction techniques, global history patterns, per-process history patterns, tournament prediction, binning techniques, and the like.

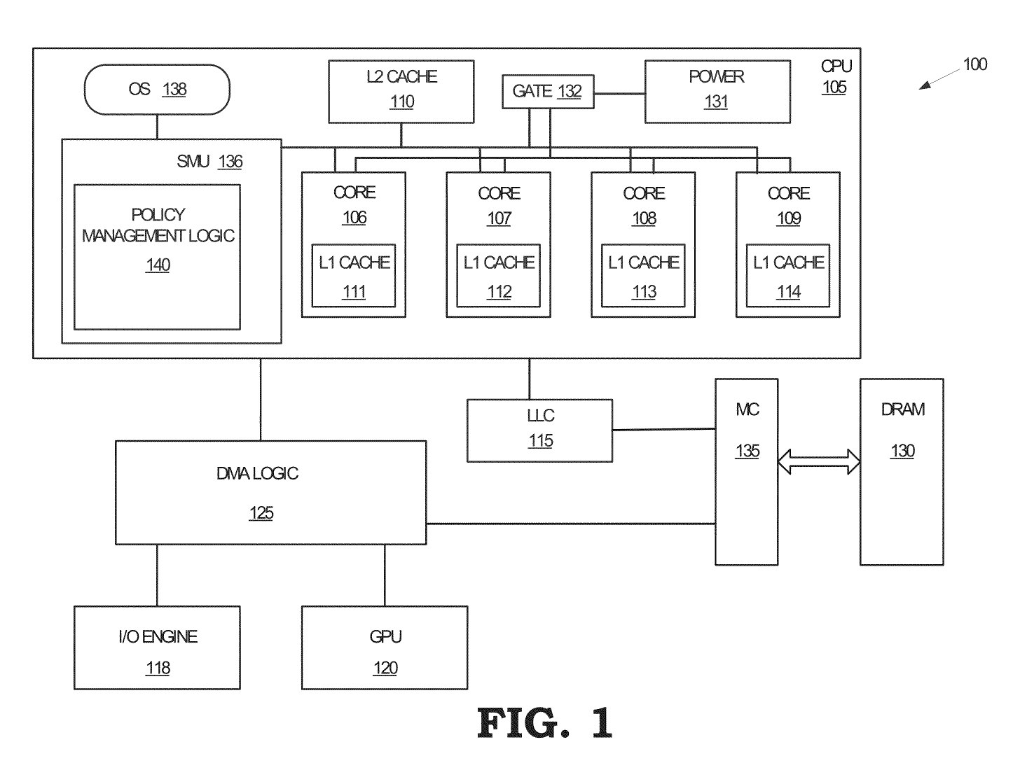

FIGS. 1-8 therefore describe embodiments of policy management logic that make performance policy decisions based on a predicted duration of an active state of one or more of the processing devices. The predicted duration of the active state may be combined with predicted durations of other states, such as idle states, to further improve the effectiveness of the performance policy decisions. For example, DVFS state management policies may be used to boost the operating frequency of a processor core when the predicted duration of the active state of the processor core is relatively short, e.g. relative to a predetermined threshold or relative to predicted durations of the idle state of the processor core. The DVFS state management policies may also be used to maintain or decrease the operating frequency when the predicted duration of the active state is relatively long. For another example, when the predicted duration of the active state is relatively short, cache management policies may change a configuration of one or more caches from a writeback cache to a write through cache to reduce overhead related to writing back dirty cache lines.

FIG. 1 is a block diagram of a processing system 100 in accordance with some embodiments. The processing system 100 includes a central processing unit (CPU) 105 for executing instructions. Some embodiments of the CPU 105 include multiple processor cores 106, 107, 108, 109 (referred to collectively as the “processor cores 106-109”) that can independently execute instructions concurrently or in parallel. The CPU 105 shown in FIG. 1 includes four processor cores 106-109. However, persons of ordinary skill in the art having benefit of the present disclosure should appreciate that the number of processor cores in the CPU 105 is a matter of design choice. Some embodiments of the CPU 105 may include more or fewer than the four processor cores 106-109 shown in FIG. 1. Some embodiments of the processing system 100 may be formed on a single substrate, e.g., as a system-on-a-chip (SOC).

The CPU 105 implements caching of data and instructions, and some embodiments of the CPU 105 may therefore implement a hierarchical cache system. For example, the CPU 105 may include an L2 cache 110 for caching instructions or data that may be accessed by one or more of the processor cores 106-109. Each of the processor cores 106-109 may also be associated with one of a plurality of L1 caches 111, 112, 113, 114 (collectively referred to as the “L1 caches 111-114”). Some embodiments of the L1 caches 111-114 may be subdivided into an instruction cache and a data cache. Some embodiments of the hierarchical cache system include additional cache levels. For example, the processing system 100 may include a last level cache (LLC) 115 that is associated with the L2 cache 110 and the L1 caches 111-114. The LLC 115 may be an L3 cache, an L4 cache, or other cache depending on the number of levels in the cache hierarchy. Some embodiments of the LLC 115 may be implemented in a separate power plane from the CPU 105 and the LLC 115 may therefore be power gated independently of the CPU 105 or entities that are part of the CPU 105.

The processing system 100 includes an input/output engine 118 for handling input or output operations associated with elements of the processing system such as keyboards, mice, printers, external disks, and the like. A graphics processing unit (GPU) 120 is also included in the processing system 100 for creating visual images intended for output to a display. Some embodiments of the GPU 120 may include components such as multiple processor cores and/or other entities such as cache elements that are not shown in FIG. 1 interest of clarity. Cache elements in the GPU 120 may also be associated with the LLC 115 or other cache elements.

The processing system 100 shown in FIG. 1 also includes direct memory access (DMA) logic 125 for generating addresses and initiating memory read or write cycles. The CPU 105 may initiate transfers between memory elements in the processing system 100 such as the DRAM 130 and/or other entities connected to the DMA logic 125 including the CPU 105, the LLC 115, the I/O engine 118, and the GPU 120. Some embodiments of the DMA logic 125 may also be used for memory-to-memory data transfer or transferring data between the cores 106-109. The CPU 105 can perform other operations concurrently with the data transfers being performed by the DMA logic 125, which may provide an interrupt to the CPU 105 to indicate that the transfer is complete. A memory controller (MC) 135 may be used to coordinate the flow of data between the DMA logic 125, the LLC 115, and the DRAM 130. The memory controller 135 includes logic used to control reading information from the DRAM 130 and writing information to the DRAM 130.

Some embodiments of the CPU 105 may implement a system management unit (SMU) 136 that may be used to carry out policies set by an operating system (OS) 138 of the CPU 105. For example, the SMU 136 may be used to manage thermal and power conditions in the CPU 105 according to policies set by the OS 138 and using information that may be provided to the SMU 136 by the OS 138, such as power consumption by entities within the CPU 105 or temperatures at different locations within the CPU 105. The SMU 136 may therefore be able to control power supplied to entities such as the cores 106-109, as well as adjusting operating points of the cores 106-109, e.g., by changing an operating frequency or an operating voltage supplied to the cores 106-109. The SMU 136 configures caches such as the L2 cache 110, the L1 caches 111-114, or the LLC 115 according to the policies set by the OS 138. The SMU 136 may also be able to influence system software decisions such as distributing, allocating, or migrating tasks among processor cores such as the cores 106-109. The SMU 136 may further be able to control scheduling of hardware or software overhead tasks such as refreshing the DRAM 130 by periodically rewriting memory cells in the DRAM 130, performing garbage collection, or other tasks in a manner that minimizes interference with tasks performed by other processing devices in the system.

The components of the processing system 100 such as the CPU 105, the GPU 120, the cores 106-109, or the LLC 115 are able to operate in different performance states, e.g., to conserve power. Exemplary performance states may include an active state, an idle state, a power-gated state, or other performance states in which the component may consume more or less power. Some embodiments of the SMU 136 determine whether to initiate transitions between the performance states by comparing the performance or power costs of the transition with the performance gains or power savings that may result from the transition. Transitions may occur from higher to lower performance states or from lower to higher performance states. For example, some embodiments of the processing system 100 include a power supply 131 that is connected to gate logic 132. The gate logic 132 can control the power supplied to the cores 106-109 and can gate the power provided to one or more of the cores 106-109, e.g., by opening one or more circuits to interrupt the flow of current to one or more of the cores 106-109 in response to signals or instructions provided by the SMU 136. The gate logic 132 can also re-apply power to transition one or more of the cores 106-109 out of the power-gated state to an idle state or an active state, e.g., by closing the appropriate circuits. Additional gate logic (not shown in FIG. 1) may be used to power gate other entities such as the LLC 115, the GPU 120, or entities therein.

The SMU 136 may also implement policy management logic 140 that configures entities such as the CPU 105, the GPU 120, the processor cores 106-109, the L2 cache 110, the L1 caches 111-114, or the LLC 115. Configuring these entities may include operations such as increasing or decreasing operating frequencies or voltages of the CPU 105, the GPU 120, or the processor cores 106-109, configuring the L2 cache 110, the L1 caches 111-114, or the LLC 115 as write back or a write through caches, activating a selected number of ways in the L2 cache 110, the L1 caches 111-114, or the LLC 115, distributing tasks among the CPU 105, the GPU 120, the processor cores 106-109, and the like. The policy management logic 140 may configure the entities in the processing system 100 based on a predicted duration of an active state of one or more components of the processing system 100. The duration of the active state may be predicted based on one or more previous durations of an active state of the component. The predictions may be global, e.g., a single prediction can be used for all of the processor cores 106-109 based on previous durations of active states for the processor cores 106-109, or they may be local, e.g., a duration of an active state of the processor core 106 may be based only on previous durations of active states for the processor core 106. In some embodiments, the policy management logic 140 may also configure entities in the processing system 100 based on predicted durations of other performance states such as idle states.

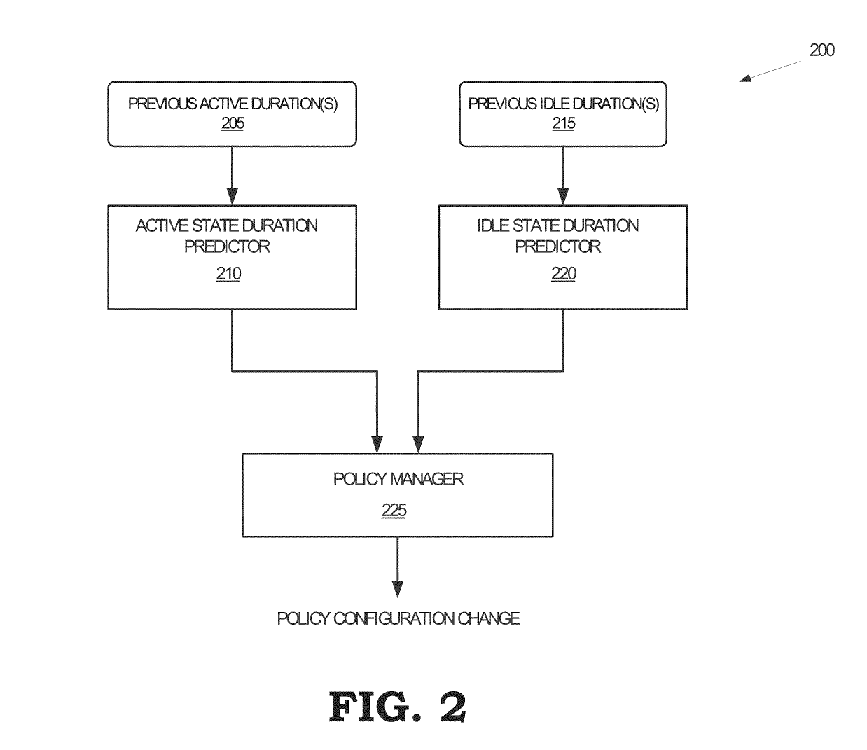

FIG. 2 is a block diagram of policy management logic 200 that may be used as the policy management logic 140 shown in FIG. 1 according to some embodiments. The policy management logic 200 receives information 205 indicating the durations of one or more previous active states of one or more components of a processing system such as the processing system 100 shown in FIG. 1. As discussed herein, this information may be stored in a table or other data structure that may be updated in response to one or more components entering or leaving the active state. An active state duration predictor 210 may then use this information to predict a duration of an active state of a component of the processing system. For example, the processing system may activate a processor core such as one of the processor cores 106-109 shown in FIG. 1 to perform a task such as executing instructions for a process thread. The active state duration predictor 210 may then predict the duration of the active state, e.g., in response to a signal indicating that the processor core is going to be activated or in response to a signal indicating that the processor core has been activated.

Some embodiments of the policy management logic 200 may also access information 215 indicating durations of one or more previous idle states (or other performance states) of one or more components of a processing system such as the processing system 100 shown in FIG. 1. An idle state duration predictor 220 may then use this information to predict a duration of an idle state of a component of the processing system. In some embodiments, the predicted idle state duration may be compared to the predicted duration of an active state. The idle state duration predictor 220 may therefore predict the duration of an idle state in response to activation of a processor core such as one of the processor cores 106-109 shown in FIG. 1.

The active state duration predictor 210 and, if implemented, the idle state duration predictor 220 may predict durations of the active and idle states, respectively, using one or more prediction techniques. The active state duration predictor 210 and the idle state duration predictor 220 may use the same prediction techniques or they may use different prediction techniques, e.g., if the different prediction techniques may be expected to provide more accurate predictions of the durations of active states and durations of idle states.

Some embodiments of the active state duration predictor 210 or the idle state duration predictor 220 may use a last value predictor to predict durations of the active or idle states. For example, to predict the duration of an active state, the active state duration predictor 210 accesses a value of a duration of an active state associated with a component in a processing device when a table that stores the previous durations is updated, e.g., in response to the component entering the idle state so that the total duration of the previous active state can be measured by the last value predictor. The total duration of the active state is the time that elapses between entering the active state and transitioning to the idle state or other performance state. The updated value of the duration is used to update an active state duration history that includes a predetermined number of durations of previous active states. For example, the active state duration history, Y(t), may include information indicating the durations of the last ten active states so that the training length of the last value predictor is ten. The training length is equal to the number of previous active states used to predict the duration of the next active state.

The active state duration predictor 210 may then calculate an average of the durations of the active states in the active state history, e.g., using equation (1) for computing the average of the last ten active states:

Y̅(̅t̅)̅=Σᵢ₌₁¹⁰0.1*Y(t−i) (1)

Some embodiments of the active state duration predictor 210 may also generate a measure of the prediction error that indicates the proportion of the signal that is well modeled by the last value predictor model. For example, the active state duration predictor 210 may produce a measure of prediction error based on the training data set. Measures of the prediction error may include differences between the durations of the active states in the active state history and the average value of the durations of the active states in the active state history. The measure of the prediction error may be used as a confidence measure for the predicted duration of the active state.

Some embodiments of the active state duration predictor 210 or the idle state duration predictor 220 may use a linear predictor to predict durations of the performance states. For example, the active state duration predictor 210 may access measured value(s) of the duration of the previous active state to update an active state duration history that includes a predetermined number of previous active state durations that corresponds to the training length of the linear predictor. For example, the active state duration history, Y(t), may include information indicating the durations of the last N active states so that the training length of the linear predictor is N. the active state duration predictor 210 mailing compute a predetermined number of linear predictor coefficients a(i). The sequence of active state durations may include different durations and the linear predictor coefficients a(i) may be used to define a model of the progression of active state durations that can be used to predict the next active state duration.

The active state duration predictor 210 may compute a weighted average of the durations of the idle events in the idle event history using the linear predictor coefficients a(i), e.g., using equation (2) for computing the average of the last N idle events:

Y̅(̅t̅)̅=Σᵢ₌₁^{N}a(i)*Y(t−i) (2)

Some embodiments of the linear predictor algorithm may use different training lengths and/or numbers of linear predictor coefficients. Some embodiments of the active state duration predictor 210 may also generate a measure of the prediction error that indicates the proportion of the signal that is well modeled by the linear predictor model, e.g., how well the linear predictor model would have predicted the durations in the active state history. For example, the active state duration predictor 210 may produce a measure of prediction error based on the training data set. The measure of the prediction error may be used as a confidence measure for the predicted active state duration.

Some embodiments of the active state duration predictor 210 or the idle state duration predictor 220 may use a filtered linear predictor to predict durations of the active states or idle states. For example, the active state duration predictor 210 may filter an active state duration history, Y(t), to remove outlier idle events such as events that are significantly longer or significantly shorter than the mean value of the active state durations in the history. The active state duration predictor 210 may then compute a predetermined number of linear predictor coefficients a(i) using the filtered idle event history. The active state duration predictor 210 may also compute a weighted average of the durations of the idle events in the filtered idle event history using the linear predictor coefficients a(i), e.g., using equation (3) for computing the weighted average of the last N idle events in the filtered idle event history Y′:

Y̅(̅t̅)̅=Σᵢ₌₁^{N}a(i)*Y′(t−i) (3)

Some embodiments of the filtered linear predictor algorithm may use different filters, training lengths, and/or numbers of linear predictor coefficients. Some embodiments of the active state duration predictor 210 may also generate a measure of the prediction error that indicates the proportion of the signal that is well modeled by the filtered linear predictor model. The measure of the prediction error may be used as a confidence measure for the predicted active state duration.

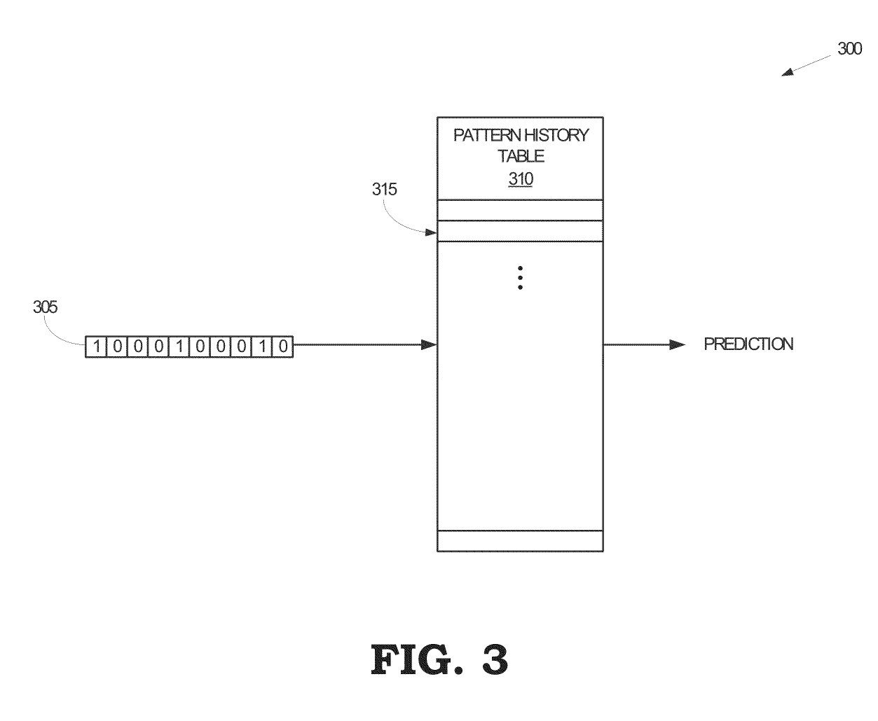

FIG. 3 is a diagram of a two-level adaptive global predictor 300 that may be used by the active state duration predictor 210 or the idle state duration predictor 220 shown in FIG. 2 in accordance with some embodiments. The two levels used by the global predictor 300 correspond to long and short durations of a performance state. For example, a value of “1” may be used to indicate an active state that has a duration that is longer than a threshold and a value of “0” may be used to indicate an active state that has a duration that is shorter than the threshold. The threshold may be set based on one or more performance policies, as discussed herein. The global predictor 300 receives information indicating the duration of active states and uses this information to construct a pattern history 305 for long or short duration events. The pattern history 305 includes information for a predetermined number N of active states, such as the ten active states shown in FIG. 3.

A pattern history table 310 includes 2^{N} entries 315 that correspond to each possible combination of long and short durations in the N active states. Each entry 315 in the pattern history table 310 is also associated with a saturating counter that can be incremented or decremented based on the values in the pattern history 305. An entry 315 may be incremented when the pattern associated with the entry 315 is received in the pattern history 305 and is followed by a long-duration active state. The saturating counter can be incremented until the saturating counter saturates at a maximum value (e.g., all “1s”) that indicates that the current pattern history 305 is very likely to be followed by a long duration active state. An entry 315 may be decremented when the pattern associated with the entry 315 is received in the pattern history 305 and is followed by a short-duration active state. The saturating counter can be decremented until the saturating counter saturates at a minimum value (e.g., all “0s”) that indicates that the current pattern history 305 is very likely to be followed by a short duration active state.

The two-level global predictor 300 may predict that an active state is likely to be a long-duration event when the saturating counter in an entry 315 that matches the pattern history 305 has a relatively high value of the saturating counter such as a value that is close to the maximum value. The two-level global predictor 300 may predict that an active state is likely to be a short-duration event when the saturating counter in an entry 315 that matches the pattern history 305 has a relatively low value of the saturating counter such as a value that is close to the minimum value.

Some embodiments of the two-level global predictor 300 may also provide a confidence measure that indicates a degree of confidence in the current prediction. For example, a confidence measure can be derived by counting the number of entries 315 that are close to being saturated (e.g., are close to the maximum value of all “1s” or the minimum value of all “0s”) and comparing this to the number of entries that do not represent a strong bias to long or short duration active states (e.g., values that are approximately centered between the maximum value of all “1s” and the minimum value of all “0s”). If the ratio of saturated to unsaturated entries 315 is relatively large, the confidence measure indicates a relatively high degree of confidence in the current prediction and if this ratio is relatively small, the confidence measure indicates a relatively low degree of confidence in the current prediction.

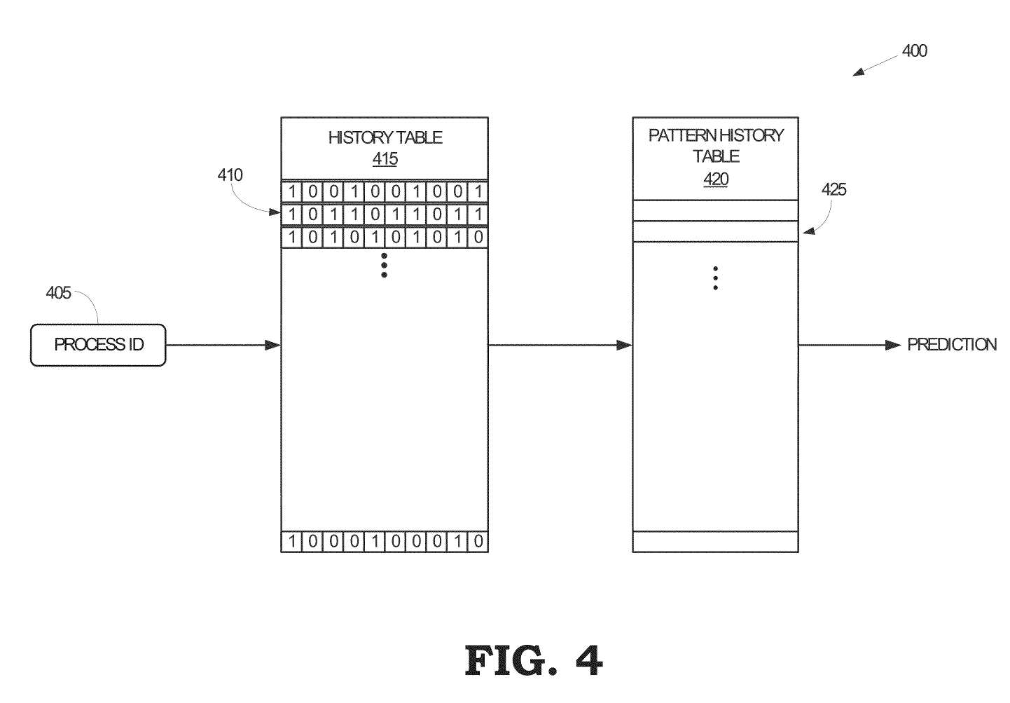

FIG. 4 is a diagram of a two-level adaptive local predictor 400 that may be used by the active state duration predictor 210 or the idle state duration predictor 220 shown in FIG. 2 in accordance with some embodiments. As discussed herein, the two levels used by the local predictor 400 correspond to long and short durations of a corresponding performance state. The two-level local predictor 400 receives a process identifier 405 that can be used to identify a pattern history entry 410 in a history table 415. Each pattern history entry 410 is associated with a process and includes a history that indicates whether previous performance state durations associated with the corresponding process were long or short. In some embodiments, the threshold that divides long durations from short durations may be set based on performance policies, as discussed herein.

A pattern history table 420 includes 2^{N} entries 425 that correspond to each possible combination of long and short durations in the N performance states in each of the entries 410. Some embodiments of the local predictor 400 may include a separate pattern history table 420 for each process. Each entry 425 in the pattern history table 420 is also associated with a saturating counter. As discussed herein, the entries 425 may be incremented or decremented when the pattern associated with the entry 425 matches the pattern in the entry 410 associated with the process identifier 405 and is followed by a long-duration event or a short-duration performance state, respectively.

The two-level local predictor 400 may then predict that a performance state is likely to be a long-duration event when the saturating counter in an entry 425 that matches the pattern in the entry 410 associated with the process identifier 405 has a relatively high value of the saturating counter such as a value that is close to the maximum value. The two-level global predictor 400 may predict that a performance state is likely to be a short-duration performance state when the saturating counter in an entry 425 that matches the pattern in the entry 410 associated with the process identifier 405 has a relatively low value of the saturating counter such as a value that is close to the minimum value.

Some embodiments of the two-level local predictor 400 may also provide a confidence measure that indicates a degree of confidence in the current prediction. For example, a confidence measure can be derived by counting the number of entries 425 that are close to being saturated (e.g., are close to the maximum value of all “1s” or the minimum value of all “0s”) and comparing this to the number of entries 425 that do not represent a strong bias to long or short duration performance states (e.g., values that are approximately centered between the maximum value of all “1s” and the minimum value of all “0s”). If the ratio of saturated to unsaturated entries 425 is relatively large, the confidence measure indicates a relatively high degree of confidence in the current prediction and if this ratio is relatively small, the confidence measure indicates a relatively low degree of confidence in the current prediction.

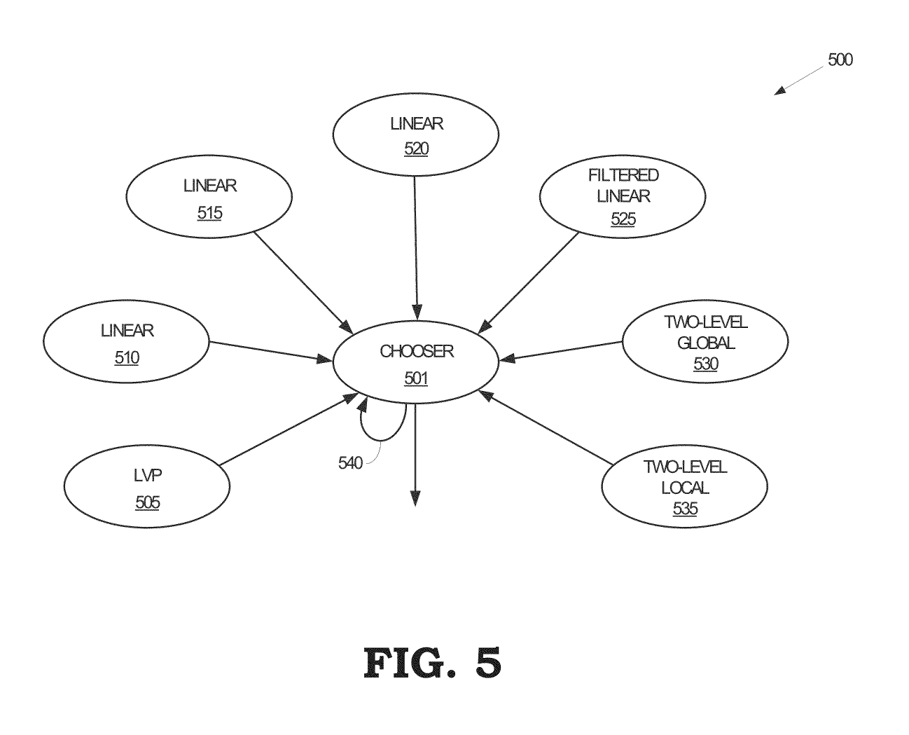

FIG. 5 is a block diagram of a tournament predictor 500 that may be implemented in the active state duration predictor 210 or the idle state duration predictor 220 shown in FIG. 2 in accordance with some embodiments. The tournament predictor 500 includes a chooser 501 that is used to select one of a plurality of predictions of a duration of a performance state provided by a plurality of different prediction algorithms, such as a last value predictor 505, a first linear prediction algorithm 510 that uses a first training length and a first set of linear coefficients, a second linear prediction algorithm 515 that uses a second training length and a second set of linear coefficients, a third linear prediction algorithm 520 that uses a third training length and a third set of linear coefficients, a filtered linear prediction algorithm 525 that uses a fourth training length and a fourth set of linear coefficients, a two-level global predictor 530, and a two-level local predictor 535. However, selection of algorithms shown in FIG. 5 is intended to be exemplary and some embodiments may include more or fewer algorithms of the same or different types.

Referring back to FIG. 2, the policy management logic 200 includes a policy manager 225 that can implement performance policies such as policies set by the OS 138 shown in FIG. 1. The performance policies may be implemented based on predicted durations of active states generated by the active state duration predictor 210 and, in some embodiments, based on predicted durations of idle states generated by the idle state duration predictor 220. Some embodiments of the policy manager 225 may also implement policies based on predicted durations of other performance states. The policy manager 225 may be implemented in hardware, firmware, software, or a combination thereof. Policy decisions made by the policy manager 225 based on the predicted durations may include decisions made based on dynamic voltage and frequency scaling state management policies, cache management policies, or other policies related to scheduling processing tasks or overhead tasks, as discussed herein. The policy manager 225 may therefore provide signaling that can be used to configure entities in a processing system (such as the processing system 100 shown in FIG. 1) based on the policy decisions that are made using the predicted durations of the different performance states.

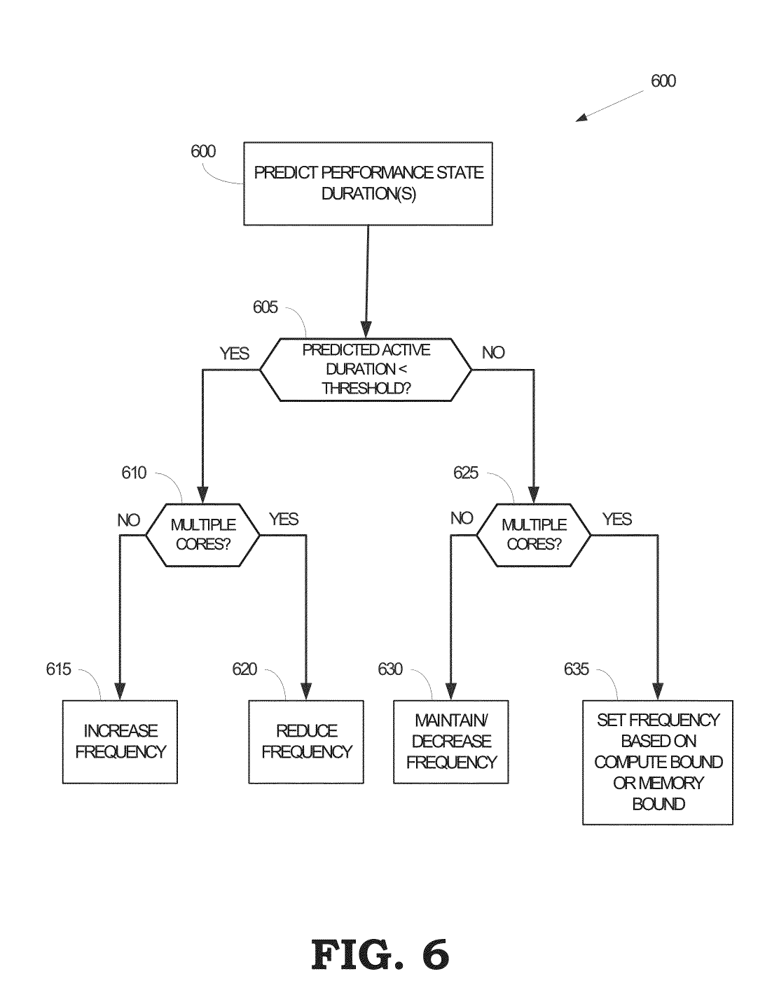

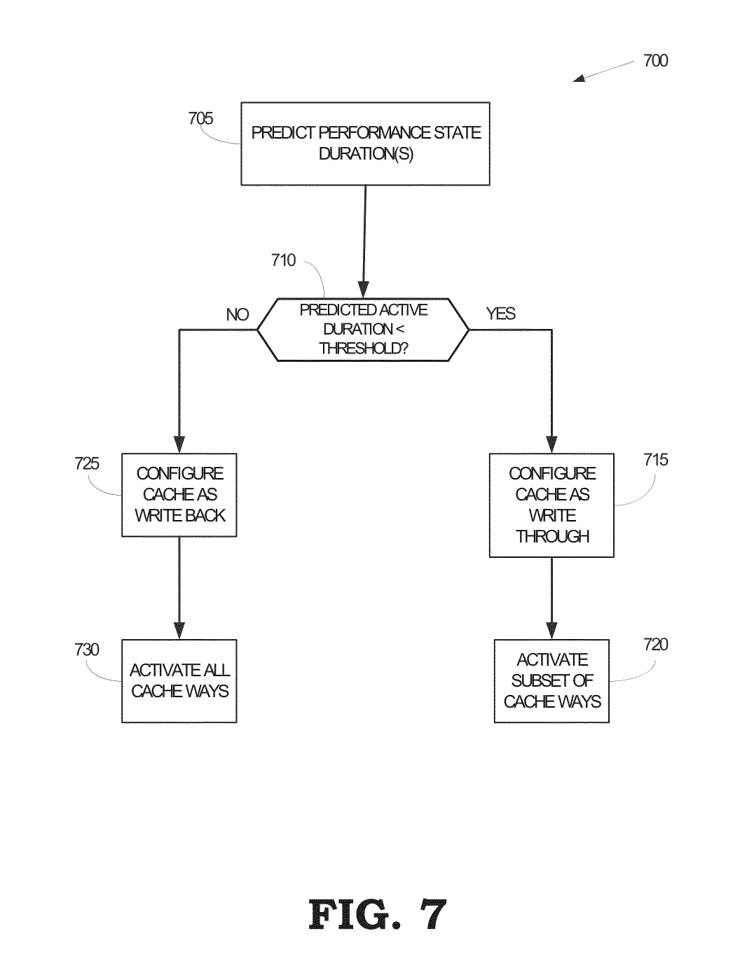

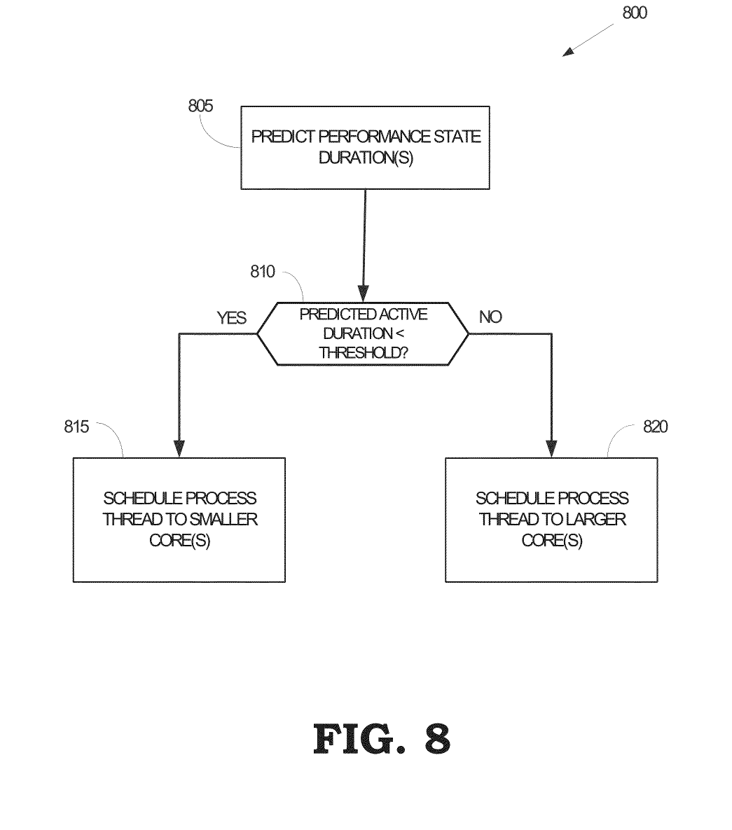

FIGS. 6-8 illustrate various examples of setting policies for the processing system 100 of FIG. 1 based on the predicted durations of the active state. For example, FIG. 6 depicts embodiments of methods for configuring the operating point of a processor core, FIG. 7 depicts embodiments of methods for configuring one or more caches associated with a processor core, and FIG. 8 depict embodiments of techniques for distributing process threads to larger or smaller cores.

FIG. 6 is a flow diagram of a method 600 of configuring a processor core such as the processor cores 106-109 shown in FIG. 1 according to some embodiments. The method 600 may be implemented in embodiments of a policy manager such as the policy manager 225 shown in FIG. 2. At block 605, the policy manager predicts durations of one or more performance states of the processor core. For example, the policy manager can predict the duration of an active state of the processor core based on previous durations of active states of the processor core or other components of a processing system that includes the processor core. Some embodiments of the policy manager may also predict the duration of an idle state or other performance state of the processor core based on previous durations of idle states of the processor core or other components of the processing system that includes the processor core.

At decision block 610, the policy manager determines whether the predicted active duration of the processor core is less than a threshold value at which a processor core can be operated at an increased frequency for the predicted active duration without causing a power overshoot or thermal violation. The threshold value may be a predetermined threshold that may be determined theoretically, empirically, or using modeling. The threshold value may also be determined based on the predicted durations of the idle state or other performance states of the processor core. For example, the threshold value may be determined so that the predicted duration of the active state is less than the threshold when a ratio of the predicted duration of the active state to the predicted duration of the idle state of the processor core is less than a threshold ratio. Other techniques may also be used to determine when the predicted duration of the active state of the processor core is relatively short and therefore falls below some threshold value. Some embodiments of the threshold value may be used to distinguish between long and short durations in one or more prediction algorithms, e.g., as discussed herein with regard to FIG. 3 and FIG. 4.

The performance of the processor core may be enhanced by boosting the operating frequency of the processor core when relatively short or medium length active durations are interspersed with relatively long idle duration. However, if multiple processor cores are predicted to be active concurrently, boosting the operating frequencies of all of the active processor cores may lead to power overshoots or thermal violations. Thus, if the predicted duration of the active state is less than the threshold, the policy manager determines (at decision block 610) whether more than one processor core is active. If not, the policy manager may provide signaling that causes the operating frequency of the processor core to be increased at block 615. If so, the operating frequency of the processor core may be reduced, e.g., to reduce the power dissipated in the processor core so that power overshoots or thermal violations may be reduced or avoided.

Thermal or power constraints may limit the benefit to boosting the operating frequency of the processor core when the predicted duration of the active state is relatively long. Moreover, if multiple processor cores are expected to be concurrently active and have relatively long predicted active states, contention between the multiple processor cores for compute or memory resources may limit performance of the processor cores, e.g., the processor cores may be compute-bounded or memory-bounded. Thus, if the predicted duration of the active state is larger than the threshold, the policy manager determines (at decision block 625) whether more than one processor core is active. If not, the policy manager may provide signaling that causes the operating frequency of the processor core to be maintained or decreased at block 630. If so, the operating frequency of the processor core may be set (at block 635) based on a compute bound or memory bound associated with the processor core.

FIG. 7 is a flow diagram of a method 700 of configuring a cache such as the L2 cache 110, the L1 caches 111-114, or the LLC 115 shown in FIG. 1 according to some embodiments. The method 700 may be implemented in embodiments of a policy manager such as the policy manager 225 shown in FIG. 2. At block 705, the policy manager predicts durations of one or more performance states of the processor core. As discussed herein, the policy manager can predict the durations of an active state of the processor core, an idle state of the processor core, or other performance states of the processor core. At decision block 710, the policy manager determines whether the predicted active duration of the processor core is less than a threshold value. As discussed herein, the threshold value may be predetermined, determined based on the predicted durations of the idle state or other performance states of the processor core, or determined using other techniques to determine when the predicted duration of the active state of the processor core is relatively short and therefore falls below some threshold value.

If the predicted duration of the active state of the processor core falls below the relevant threshold, the cache may be configured (at block 715) as a write through cache so that changes to the cache lines are also written back to a higher level cache or main memory (e.g., the L2 cache 110, the LLC 115, or the DRAM 130 shown in FIG. 1) concurrently or synchronously with writing the data to the cache line. Configuring the cache as a write through cache when the predicted duration of the active state is relatively short removes the need to write back modified (e.g., dirty) cache lines to the higher-level cache or main memory before performing performance state transitions such as power-gating the cache or an associated processor core. This may save power and reduce latency in the processing system. The policy manager may only activate (at block 720) a subset of the ways of the cache if the predicted duration of the active state falls below the threshold, which may conserve power and other processing resources associated with the cache. The policy manager may not always perform the processes represented by both blocks 715, 720 and some embodiments of the policy manager implement block 715 and do not implement block 720, some embodiments implement block 720 and do not implement block 715, and some embodiments implement both blocks 715 and 720.

If the predicted duration of the active state of the processor core is longer than the relevant threshold, the cache may be configured (at block 725) as writeback cache so that changes to the cache lines are initially only written back to the cache. Cache lines that have been modified (e.g., dirty cache lines) may subsequently be written to a higher level cache or main memory when they are evicted from the cache. The policy manager may activate (at block 730) all of the ways of the cache if the predicted duration of the active state is longer than the threshold, which may allow the full capacity of the processing system to be deployed to provide maximum performance. The policy manager may not always perform the process represented by both blocks 725, 730 and embodiments of the policy manager implement block 725 and do not implement block 730, some embodiments implement block 730 and do not implement block 725, and some embodiments implement both blocks 725 and 730.

Some embodiments of the policy manager may configure other parameters of the cache based on the predicted duration of the active state. For example, the policy manager may dynamically modify the associativity of a cache in response to changes in the predicted duration of the active state. Depending upon circumstances, the associativity of the cache may be increased or decreased in response to the predicted duration of the active state increasing or decreasing. For another example, the policy manager may dynamically modify the size of cache lines in the cache in response to changes in the predicted duration of the active state. Depending upon circumstances, the size of a cache line may be increased or decreased in response to the predicted duration of the active state increasing or decreasing. For yet another example, the policy manager may schedule eviction of modified cache lines to attempt to complete the eviction before the active state is predicted to end, which may help reduce the overhead required to power-gate the cache or an associated processor.

FIG. 8 is a flow diagram of a method 800 of configuring a processing device that has multiple cores such as the CPU 105 shown in FIG. 1 according to some embodiments. The method 800 may be implemented in embodiments of a policy manager such as the policy manager 225 shown in FIG. 2. In some embodiments, a first subset of the processor cores may be considered “larger” cores and a second subset of the processor cores may be considered “smaller” cores. For example, larger cores may utilize a larger cache, have a deeper instruction pipeline, support out-of-order instruction execution, or be implemented using an x86 instruction set architecture. For another example, smaller cores may utilize a smaller cache, have a shallower instruction pipeline, allow only in-order instruction execution, or be implemented using an ARM instruction set architecture. Larger cores typically exact a higher power cost to perform tasks and smaller cores exact a lower power cost. The policy manager may therefore distribute process threads among the larger and smaller cores based on predicted durations of the performance states of the processor cores.

At block 805, the policy manager predicts durations of one or more performance states of the processor cores in the processing device. As discussed herein, the policy manager can predict the durations of an active state of the processor cores, an idle state of the processor cores, or other performance states of the processor cores. At decision block 810, the policy manager determines whether the predicted active duration of the processor cores is less than a threshold value. As discussed herein, the threshold value may be predetermined, determined based on the predicted durations of the idle state or other performance states of the processor core, or determined using other techniques to determine when the predicted duration of the active state of the processor core is relatively short and therefore falls below some threshold value.

If the predicted duration of the active state is less than the threshold value, the process thread may be scheduled (at block 820) to one of the smaller cores. Scheduling process threads that have a shorter duration to one of the smaller cores may conserve power because the smaller cores exact a lower power cost. If the predicted duration of the active state is longer than the threshold value, the process thread may be scheduled (at block 825) the one of the larger threads. Scheduling process threads that have a longer duration to one of the larger cores may improve the performance of the system by allowing larger capacity of the larger core(s) to work on the process thread.

In some embodiments, the apparatus and techniques described above are implemented in a system comprising one or more integrated circuit (IC) devices (also referred to as integrated circuit packages or microchips), such as the policy management logic described above with reference to FIGS. 1-8. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

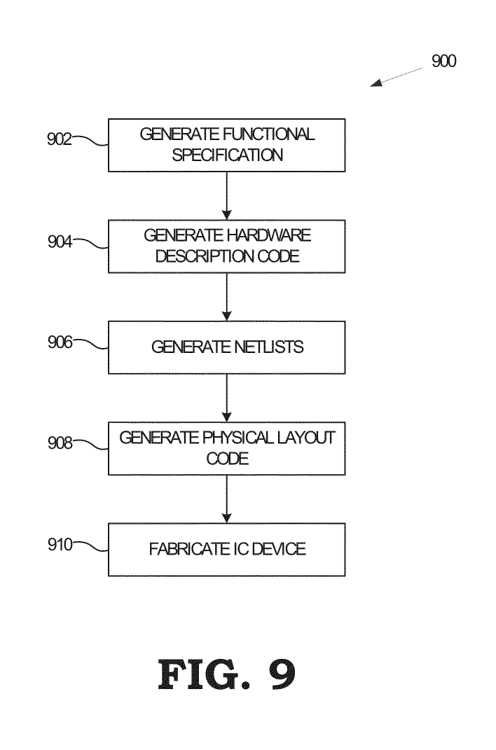

FIG. 9 is a flow diagram illustrating an example method 900 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 902 a functional specification for the IC device is generated. The functional specification (often referred to as a micro architecture specification (MAS)) may be represented by any of a variety of programming languages or modeling languages, including C, C++, SystemC, Simulink, or MATLAB.

At block 904, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 906 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 908, one or more EDA tools use the netlists produced at block 906 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 910, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
configuring a first component in a processing system based on a predicted duration of an active state of a second component of the processing system, wherein the predicted duration is predicted based on at least one previous duration of an active state of the second component.

2. The method of claim 1, further comprising:
predicting the duration of the active state of the second component using at least one of: a linear prediction technique, a filtered linear prediction technique, a global history pattern, a per-process history pattern, tournament prediction, or a binning technique.

3. The method of claim 1, wherein configuring the first component in the processing system comprises configuring at least one of an operating frequency or an operating voltage provided to the second component during the active state.

4. The method of claim 3, wherein configuring the at least one of the operating frequency or the operating voltage comprises increasing the operating frequency of the second component in response to the predicted duration being shorter than a threshold and maintaining or decreasing the operating frequency of the second component in response to the predicted duration being longer than the threshold.

5. The method of claim 3, wherein configuring the at least one of the operating frequency or the operating voltage comprises increasing the operating frequency of the second component in response to a ratio of the predicted duration of the active state to a predicted duration of an idle state of the second component being smaller than a threshold and maintaining or decreasing the operating frequency of the second component in response to the ratio being larger than the threshold.

6. The method of claim 1, wherein configuring the first component comprises configuring at least one cache associated with the second component of a processing system.

7. The method of claim 6, wherein configuring the at least one cache comprises configuring the at least one cache as a writeback cache in response to the predicted duration being shorter than a threshold and configuring the at least one cache as a write through cache in response to the predicted duration being longer than the threshold.

8. The method of claim 6, wherein configuring the at least one cache comprises activating a number of ways of the at least one cache, wherein the number of ways is selected based on the predicted duration.

9. The method of claim 6, wherein configuring the at least one cache comprises scheduling a time for eviction of modified lines in the cache based on the predicted duration.

10. The method of claim 1, wherein the second component is one of a plurality of processor cores, and wherein configuring the first component in the processing system comprises distributing tasks among the processor cores based on the predicted duration.

11. A processing system, comprising:
a plurality of components including a first component and a second component; and
policy management logic to predict a duration of an active state of a first component based on at least one previous duration of an active state of the first component and to configure a second component of the processing system based on the predicted duration of the active state of the first component.

12. The processing system of claim 11, wherein the second component in the processing system comprises the first component, and wherein at least one of an operating frequency or an operating voltage provided to the second component during the active state are configurable based on the predicted duration.

13. The processing system of claim 12, wherein the operating frequency of the second component is increased in response to the predicted duration being shorter than a threshold, and wherein the operating frequency of the second component is maintained or decreased in response to the predicted duration being longer than the threshold.

14. The processing system of claim 13, wherein the operating frequency of the second component is increased in response to a ratio of the predicted duration of the active state to a predicted duration of an idle state of the first component being smaller than a threshold, and wherein the operating frequency of the second component is maintained or decreased in response to the ratio being larger than the threshold.

15. The processing system of claim 11, wherein the second component comprises at least one cache that is configurable based on the predicted duration.

16. The processing system of claim 15, wherein the at least one cache is configurable as a writeback cache in response to the predicted duration being shorter than a threshold, and wherein the at least one cache is configurable as a write through cache in response to the predicted duration being longer than the threshold.

17. The processing system of claim 15, wherein a selectable number of ways of the at least one cache can be activated based on the predicted duration.

18. The processing system of claim 15, wherein a time for eviction of modified lines from the at least one cache comprises can be scheduled based on the predicted duration.

19. The processing system of claim 11, comprising a plurality of processor cores, wherein the first component and the second component are each one of the plurality of processor cores, and wherein tasks can be distributed among the processor cores based on the predicted duration.

20. A non-transitory computer readable medium embodying a set of executable instructions, the set of executable instructions to manipulate at least one processor to:
configure a first component in a processing system based on a predicted duration of an active state of a second component of the processing system, wherein the predicted duration is predicted based on at least one previous duration of an active state of the second component.
